(19) United States
(12) Patent Application Publication
(10) Pub. No.: US 2006/0086228 A1
(43) Pub. Date: Apr. 27, 2006

(54) Tube cutting process and device

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/971,578

(22) Filed: Oct. 22, 2004

(51) Int. Cl. B26D 7/06; B26D 1/12

(52) U.S. Cl. 83/666; 83/402

(57) ABSTRACT

The tube cutting process and device comprises of a cutting mechanism, an ejecting mechanism, and a stacking mechanism. An extruded plastic tube is fed after the extrusion process to the cutting mechanism to be cut into short sections. The ejecting mechanism then ejects the short sections in a controlled manner into a stacking mechanism. The stacking mechanism then stacks the short sections into an organized pile wherein the short sections are all in the same orientation and direction.

### BACKGROUND

1. Field of Invention The present invention relates generally to a process and a device for cutting an elongated cylindrical member. More specifically, the present invention relates to an automated process and device for cutting a plastic cylindrical tube and maintaining the orientation of the cut sections in the same direction.

2. Description of Related Art

An elongated plastic cylindrical member may be formed by the extrusion process. To manufacture plastic pipe, industry uses a process known as Profile Extrusion. This process is used to manufacture plastic products with a continuous cross-section such as drinking straws, plastic evestroughing, decorative molding, window trimming, and a wide variety of other products polymer melt into the hollow mold cavity under high pressure.

The plastic resin is fed in pellet form into the machines hopper (this machine is known as an Extruder), the material is conveyed continuously forward by a rotating screw inside a heated barrel being softened by both friction and heat. The softened plastic is then forced out through a die and directly into cool water where the product solidifies. From here it is conveyed onwards into the take-off rollers, which actually do the pulling of the softened plastic from the die. The solidified plastic is then fed through a set of dies at which time it is sliced into predetermined lengths by a rotating knife.

The die is a metal plate placed at the end of the extruder with a section cut out of its interior, this cutout, and the speed of the take-off rollers, determines the cross-section of the product being manufactured.

[image]

A tube is one of the more common types of plastic product we are familiar with. A tube is produced by an extrusion process. Basically extrusion can be defined as forcing a material through a die orifice. This die orifice produces the final shape of the finished product.

Plastic tube, sheet, wire, and profile shapes are all also manufactured by this process. In fact, the plastic resin granules or pellets used for injection molding are produced by extrusion. A long strand or filament of extruded plastic is chopped or cut into pellet-sized pieces to produce plastic injection molding materials.

Extrusion produces an inherently strong finished product. More so than a molding process. This is one of the reasons that plastic pipe is rated at higher pressures than injection molded plastic fittings.

After the extrusion and cutting process in accordance with the prior art, a pile of tubular sections of the plastic tube in random orientations and directions is obtained. The tubular sections will then need to be sorted and placed in the same orientation and direction to be processed further in the manufacturing process into the final product. The sorting of the tubular sections is generally performed with a machine that vibrates and shakes the pile of tubular sections through a sorter to place the tubular sections into a container in the same orientation and direction.

### BRIEF SUMMARY OF THE INVENTION

An objection of the present invention is to cut an elongated cylindrical member into small sections and place them in the same orientation and direction. Another object of the present invention is to cut an elongated tube into small sections and place them in the same orientation and direction. Yet another object of the present invention is to eliminate the need to sort the small sections of tubes after they are cut.

The tube cutting process and device comprises of a cutting means, an ejecting means, and a stacking means. An extruded plastic tube is fed after the extrusion process to the cutting means to be cut into short sections. The ejecting means then ejects the short sections in a controlled manner into a stacking means. The stacking means then stacks the short sections into an organized pile wherein the short sections are all in the same orientation and direction.

### BRIEF DESCRIPTION OF THE DRAWINGS

FIG. 1 shows the preferred embodiment of the tube cutting process and device before the blade cuts through the elongated member.

FIG. 2 shows a detailed view of the preferred embodiment of the tube cutting process and device after the blade cuts through the elongated member.

FIG. 3 shows the preferred embodiment of the stacking means in the tube cutting process and device after the blade cuts through the elongated member.

FIG. 4 shows an enlarged view of the preferred embodiment of the tube cutting process and device after the blade cuts through the elongated member.

FIG. 5 shows the side view of the preferred embodiment of the tube cutting process and device shown in FIG. 4.

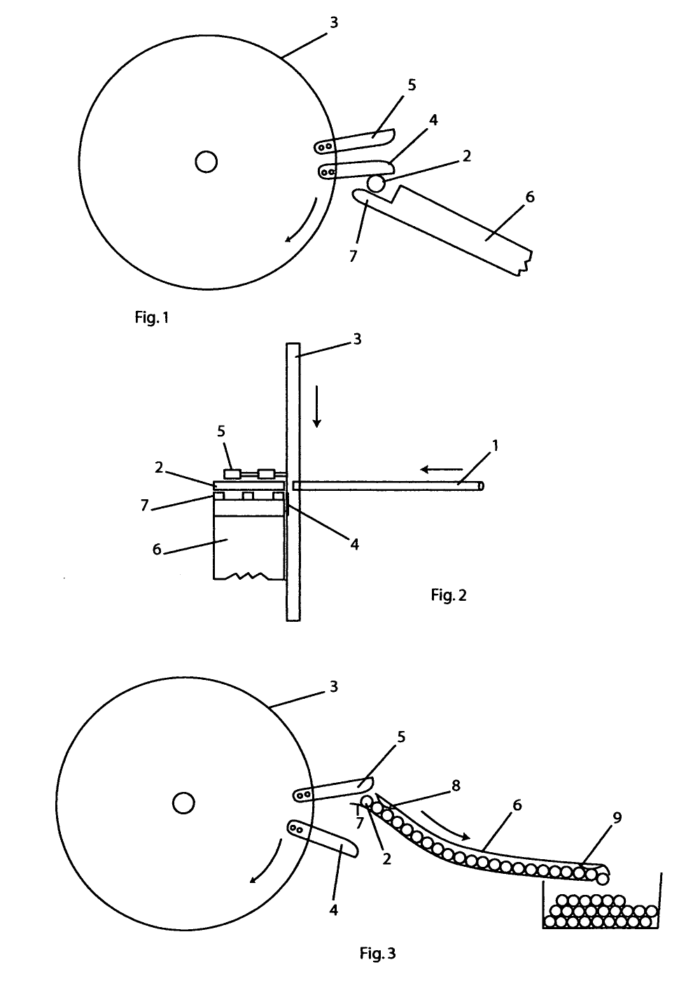

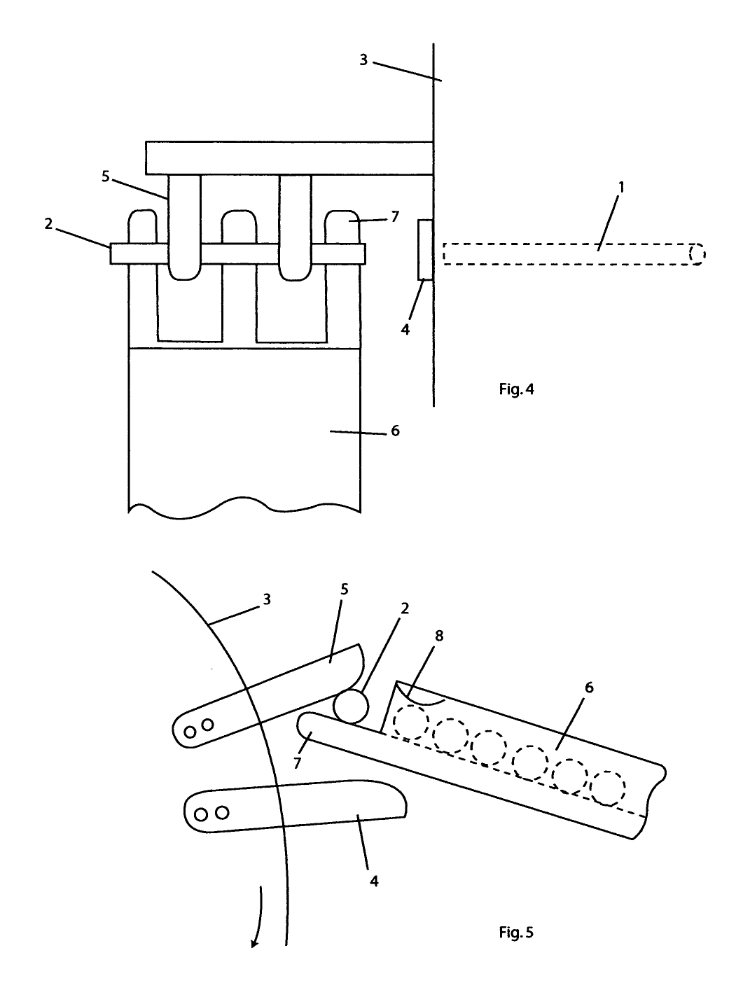

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

The tube cutting process and device comprises of a cutting means, an ejecting means, and a stacking means. An extruded plastic tube 1 is fed after the extrusion process to the cutting means to be cut into short sections 2. The ejecting means then removes the short sections 2 in a controlled manner into a stacking means. The stacking means then stacks the short sections 2 into an organized pile wherein the short sections 2 are all in the same orientation and direction. The short sections 2 of plastic tubes may then be placed in a container or transferred to the next stage in the manufacturing process to be made into the final product.

In the preferred embodiment, which is shown in the figures, the cutting means comprises of a rotating wheel 3 with a cutting blade 4 protruding from its edge. When the wheel 3 is rotating at a constant speed, the cutting blade 4 is moving through a cutting point near the wheel's circumference at a regular interval. This interval will determine the length of the tube sections 2. As the extruded plastic tube 1 is directed perpendicular to the plane of the wheel 3 through the cutting point, the plastic tube 1 will move past the wheel 3 at a constant speed. The cutting blade 4 will intercept the plastic tube 1 at a fixed time interval determined by the wheel's rotational speed. The tube sections 2 will be shorter when the wheel 3 is rotating at a higher speed whereas the tube sections 2 will be longer when the wheel 3 is rotating at a slower speed. Therefore, the length of the tube sections 2 that are being cut can be predetermined by controlling the rotational speed of the wheel 3.

In another embodiment of the cutting means, a step-motor is used to move a cutting blade at a predetermined interval across the plastic tube 1 and cutting the plastic tube 1 into short sections 2. The step-motor can be selected to move the cutting blade at any predetermined interval and speed across the plastic tube 1 thereby cutting the plastic tube 1 into short sections 2 of any desired length. In yet another embodiment, a piston may be used to move a cutting blade at a predetermined interval across the plastic tube 1 to cut the plastic tube 1 into short sections 2.

As shown in the figures, the ejecting means in the preferred embodiment comprises of one or more protrusions 5 that is affixed at a predetermined distance circumferentially behind the cutting blade 4 on the wheel 3. The circumferential distance is such that the protrusions 5 will remove the short section 2 immediately after the cutting blade 4 cuts through the plastic tube 1. At that instance in time, the short section 2 will have been severed from the plastic tube 1, yet has not had the time to move substantially away from its original location due to its inertia. After the cutting blade 4 cuts through the plastic tube 1, the ejecting means will remove the short cut-off section 2 of the plastic tube 1 in a controlled manner away from the advancing extruded plastic tube 1 and into the stacking means. An alternate embodiment of the ejecting means comprises of an air jet that will push and remove the short section 2 of the plastic tube away from the advancing extruded plastic tube 1, after it is cut, to the stacking means.

In the preferred embodiment, the stacking means comprises of a conduit 6 with a width approximately the same length as the length of the short cut-off sections 2 of the plastic tube and with a height of approximately the diameter of the short cut-off sections 2 of the plastic tube. The length of the conduit 6 is selected such that it will extend from approximately the cutting blade 4 to a predetermined location where the short sections 2 of the plastic tubes are to be packaged or transferred to the next station in the manufacturing process, as shown in FIG. 3. In the preferred embodiment, the end of the conduit 6 near the ejecting means has one or more protrusions 7 similar to the protrusions 5 in the ejecting means which are positioned offset to the protrusions 5 in the ejecting means. The protrusions 7 at the end of the conduit 6 are positioned such that it will allow passage of the protrusions 5 in the ejecting means in between the protrusions 7 at the end of the conduit 6. The protrusions 7 at the end of the conduit 6 are further positioned such that the angle formed between the protrusions 5 in the ejecting means and the protrusions 7 at the end of the conduit 6 will not pinch the short section 2 of plastic tube between them. The most preferred angle between the protrusions 5 in the ejecting means and the protrusions 7 at the end of the conduit 6 is the angle at which the short sections 2 plastic tube will be urged toward the conduit 6 yet still enables the two sets of protrusions 5, 7 to pass each other without being jammed by the short section 2 of plastic tube.

As shown in FIGS. 3 and 5, a leaf spring 8, 9 may be affixed to one or both ends of the conduit to ensure that the short cut-off sections 2 of plastic tubes will stack neatly adjacent to each other without leaving any gaps between the sections 2 of plastic tubes in the conduit 6. The leaf spring 8, 9 is affixed to the conduit 6 in such way that it will urge the sections 2 of plastic tube together and retain them temporarily within the conduit 6. This will prevent the sections 2 of plastic tubes from rotating in a non-axial direction or jamming in the conduit 6.

The tube cutting process and device of the present invention enables the precise cutting of an elongated cylindrical member 1 into short sections 2 and stacking the short sections 2 in the same orientation and directions. The present invention eliminates one source of contamination to the cut sections 2 by eliminating the separate sorting process that is required in the prior art. By eliminating the separate sorting process, the present invention is more efficient and more economical than the prior art. The short sections 2 of tubes that results from the present invention can be easily and quickly packaged or transferred to the next stage of the manufacturing process.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A tube cutting device comprising:
a cutting means to cut an elongated member into short sections;
an ejecting means to remove said short sections in a controlled manner; and
a stacking means to place the short sections in the same orientation and direction.

2. A tube cutting device as in claim 1, wherein said cutting means comprises of a rotating wheel with a cutting blade protruding from the circumference of said wheel.

3. A tube cutting device as in claim 1, wherein said cutting means comprises of a step-motor that is used to move a cutting blade at a predetermined interval across said elongated member and cutting said elongated member into short sections.

4. A tube cutting device as in claim 1, wherein said cutting means comprises of a piston that is used to move a cutting blade at a predetermined interval across said elongated member to cut the elongated member into short sections.

5. A tube cutting device as in claim 2, wherein said ejecting means comprises of one or more protrusions that is affixed at a predetermined distance circumferentially behind said cutting blade on said wheel.

6. A tube cutting device as in claim 1, wherein said ejecting means comprises of an air jet.

7. A tube cutting device as in claim 1, wherein said stacking means comprises of a conduit with a width approximately the same length as the length of said short sections and with a height of approximately the diameter of said short sections.

8. A tube cutting device as in claim 7, wherein an end of said conduit has one or more protrusions.

9. A tube cutting device as in claim 7, wherein a leaf spring is affixed to one or both ends of said conduit to ensure that said short sections will stack neatly adjacent to each other without leaving any gaps between said short sections in the conduit.

10. A tube cutting process comprising the steps of:
cutting an elongated member into short sections;
removing said short sections in a controlled fashion from said elongated member; and
stacking said removed short sections in the same orientation and in the same direction.

11. A tube cutting device comprising:
a rotating wheel with a cutting blade protruding from the circumference of said wheel to cut an elongated member into short sections;
one or more protrusions that is affixed at a predetermined distance circumferentially behind said cutting blade on said wheel to remove said short sections in a controlled manner; and
a conduit with a width approximately the same length as the length of said short sections and with a height of approximately the diameter of said short sections and wherein an end of said conduit has one or more protrusions and a leaf spring is affixed to one or both ends of said conduit to ensure that said short sections will stack neatly adjacent to each other without leaving any gaps between said short sections in the conduit to place the short sections in the same orientation and direction.
